(19) United States
(12) Patent Application Publication
(10) Pub. No.: US 2010/0141572 A1
(43) Pub. Date: Jun. 10, 2010

(54) ILLUMINATION DEVICE AND DISPLAY DEVICE USING THE SAME

(75) Inventor: Kentaro Kamada, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/595,675

(22) PCT Filed: Apr. 16, 2008
(86) PCT No.: PCT/JP2008/057433

§ 371 Date: Oct. 13, 2009

(30) Foreign Application Priority Data
Apr. 20, 2007 (JP) 2007-112263

(51) Int. Cl. G09G 3/36; H05B 39/00; G02B 6/04; G02B 5/02

(52) U.S. Cl. 345/102; 315/312; 362/554; 362/558

(57) ABSTRACT

An active-backlight-type image display device includes an illumination device that enables a cost reduction of a light source and can display an image more accurately by eliminating an influence on temperature characteristics. In a so-called active-backlight-type display device, an illumination device includes a plurality of light sources that correspond one to one to a plurality of divided display regions and whose number is the same as that of the divided display regions, and a light transmission medium that transmits light emitted from each of the light sources to the divided display region corresponding to the light source to irradiate the same. Brightness of the plurality of light sources is controlled individually, so that an amount of irradiation light is controlled.

### BACKGROUND OF THE INVENTION

1. Field of the Invention

The present invention relates to an illumination device for use as a backlight of a display device and a display device using the same. In particular, the present invention relates to an illumination device and a display device that can achieve lower power consumption and high gray-scale image display by controlling the brightness of a backlight.

2. Description of the Related Art

In recent years, liquid crystal display devices characterized by low power consumption, thinness, and light weight have been widely used as display devices for a television. Such a liquid crystal display device includes a liquid crystal panel as a display element, which is a so-called non-luminous display element that does not emit light by itself. Thus, an illumination device called a backlight usually is provided on the back surface of the liquid crystal panel. The liquid crystal panel controls an amount of transmission light from the backlight to be transmitted through a number of pixels, each being a unit of image display, formed in a display region, thereby displaying an image.

Since each of the pixels of the liquid crystal panel only can block light to be transmitted therethrough as a shutter, the maximum amount of light to be transmitted through the pixel never exceeds the maximum amount of light emitted from the backlight. Under the circumstances, the backlight usually is designed to continue to always irradiate the whole display region of the liquid crystal panel with the maximum amount of light as a surface light source that irradiates light uniformly.

As a result, in the case where a black image is displayed in a large portion of the display region for a long time, for example, light that does not contribute to actual image display continues to be irradiated from the backlight only to be blocked by the liquid crystal panel, which is a waste of power for lighting the backlight. Further, since each of the pixels of the liquid crystal panel does not block transmission light with 100% reliability, a phenomenon called “backlight bleeding” occurs in which brightness is not decreased sufficiently when a black image is displayed, which leads to a lower contrast of an image to be displayed on the liquid crystal panel.

In order to solve the above-described problems, a so-called active-backlight-type backlight for use in the liquid crystal display device has been proposed that irradiates each of a plurality of regions obtained by dividing the display region with a necessary amount of light in accordance with a display image, rather than continuing to always irradiate the whole display region of the liquid crystal panel with light having the same brightness (JP 2001-142409 A).

FIG. 5 is an exploded perspective view showing a schematic configuration of a conventional active-backlight-type liquid crystal display device. As shown in FIG. 5, the conventional active-backlight-type liquid crystal display device has a configuration in which a display region 55 of a liquid crystal panel 51 as a display element is divided into a plurality of regions, each of which is irradiated with a predetermined amount of irradiation light from a number of white light-emitting diodes 53 disposed on the bottom of a light source box 54 of a backlight unit 52. In FIG. 5, a control circuit for controlling the amount of irradiation light from the light-emitting diodes 53, a driving power source, and the like are not shown.

As shown in FIG. 5, the white light-emitting diodes used in the above-described conventional active-backlight-type display device have a box shape and are of a package type to emit light from their upper surfaces. Mainly, each of the package-type white light-emitting diodes in use is about 3 to 5 mm on a side on the upper surface and has a rated current of 10 to 20 mA.

However, there still is a cost problem in using a large number of the package-type light-emitting diodes as used in the above-described conventional active backlight, although a per-unit price of the package-type light-emitting diodes recently is dropping because of the economies of volume production. Further, since a number of the light-emitting diodes are disposed in the limited region, the influence of heat generated from the respective light-emitting diodes is not negligible. More specifically, in the case where some of the light-emitting diodes emit light while the others do not for a relatively long time, an ambient temperature rises in a region surrounded by the light-emitting diodes that emit light, and accordingly may vary from an ambient temperature in a region surrounded by the light-emitting diodes that are extinguished. The variation in the ambient temperature of the light-emitting diodes has an influence on temperature characteristics of the light-emitting diodes, so that slightly different emission brightness is obtained by applying the same current, which may make it impossible to display an image accurately in each of the divided display regions.

### SUMMARY OF THE INVENTION

In view of the above-described problems, preferred embodiments of the present invention provide a so-called active-backlight-type display device allowing irradiation brightness to be controlled individually for each of a plurality of divided display regions that enables a cost reduction of a light source and can display an image more accurately by eliminating an influence on temperature characteristics, and an illumination device suitable for use in this display device.

An illumination device according to a preferred embodiment of the present invention is an illumination device for use in a display device that is capable of irradiating each of a plurality of divided irradiation regions with an amount of light controlled individually. The device includes: a plurality of light sources that correspond one to one to the plurality of divided irradiation regions and whose number is the same as that of the divided irradiation regions; and a light transmission medium that transmits light emitted from each of the light sources to the divided irradiation region corresponding to the light source to irradiate the same. Brightness of the plurality of light sources is controlled individually, so that an amount of light irradiated onto each of the plurality of divided irradiation regions is controlled.

Further, a display device according to a preferred embodiment of the present invention includes: a display element that controls an amount of transmission light to be transmitted through pixels, thereby displaying an image in a display region; and an illumination device that irradiates each of a plurality of divided display regions obtained by dividing the display region with an amount of light controlled individually. The display device controls an amount of irradiation light from the illumination device for each of the divided display regions and transmittance of each of the pixels corresponding to the amount of irradiation light based on an input vide signal, thereby displaying an image. The illumination device includes: a plurality of light sources that correspond one to one to the plurality of divided display regions and whose number is the same as that of the divided display regions; and a light transmission medium that transmits light emitted from each of the light sources to the divided display region corresponding to the light source to irradiate the same. Brightness of the plurality of light sources is controlled individually, so that the amount of irradiation light is controlled.

According to various preferred embodiments of the present invention, it is possible to provide an illumination device that can achieve a cost reduction and control brightness accurately by eliminating non-uniform brightness caused by an ambient temperature variation, as an active-backlight-type illumination device allowing an amount of irradiation light to be controlled individually for each of divided irradiation regions. Further, when the illumination device according to one of the preferred embodiments of the present invention is used as an active-backlight-type backlight for a display element that controls an amount of transmission light to be transmitted through pixels, thereby displaying an image in a display region, it is possible to realize a display device that can achieve lower power consumption and prevent the backlight light source from being influenced in temperature characteristics by an ambient temperature, thereby displaying a high-quality image by accurate brightness control.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing a schematic configuration of a liquid crystal display device according to a preferred embodiment of the present invention.

FIG. 2 is an exploded perspective view of a liquid crystal display device according to a preferred embodiment of the present invention.

FIG. 3 is a view showing a configuration of a main portion of a backlight unit according to a preferred embodiment of the present invention.

FIG. 4 is a view showing a configuration of a main portion of a backlight unit according to a preferred embodiment of the present invention.

FIG. 5 is an exploded perspective view showing a conventional active-backlight-type liquid crystal display device.

### DETAILED DESCRIPTION OF THE PREFERRED EMBODIMENTS

An illumination device according to preferred embodiments of the present invention preferably is an illumination device for use in a display device that is capable of irradiating each of a plurality of divided irradiation regions with an amount of light controlled individually. The device includes a plurality of light sources that correspond one to one to the plurality of divided irradiation regions and whose number is the same as that of the divided irradiation regions, and a light transmission medium that transmits light emitted from each of the light sources to the divided irradiation region corresponding to the light source to irradiate the same. Brightness of the plurality of light sources is controlled individually, so that an amount of light irradiated onto each of the plurality of divided irradiation regions is controlled.

With this configuration, light is irradiated by the light transmission medium between each of the light sources and the divided irradiation region corresponding to the light source. This increases the degree of freedom in the locations of the light sources, and eases limitations on the number of the light sources. Therefore, it is possible to obtain an illumination device that can be applied suitably as a highly practical active-backlight-type backlight.

Further, in the above configuration, each of the light sources preferably is provided on a side wall of a light source box containing the light sources and the light transmission medium therein. Consequently, it is possible to prevent effectively a variation in temperature characteristics that is caused when an ambient temperature of each of the light sources rises by heat generated from other light sources surrounding the same.

Further, the light sources are preferably white light-emitting diodes. Consequently, it is possible to obtain a light source that can emit white light, which is most suitable as backlight light for a display element, and provide a sufficient amount of light with a small area. Light from this light source can be transmitted and irradiated onto the corresponding irradiation region easily by means of the light transmission medium.

Further, the light transmission medium is preferably an optical fiber. An optical fiber enables free design as to the length of a transmission path, the degree of bending, and the like, and has significantly excellent practicality as a high-efficiency light transmission medium.

Further, it is more preferable that the light transmission medium is a collection of a plurality of the optical fibers, which extend radially at an end portion on the divided irradiation region side. Consequently, light from each of the light sources can be transmitted and irradiated uniformly onto the divided irradiation region that has a larger area than a light-emitting surface of the light source.

Further, the light transmission medium may be a light guide that includes an optical member having a light diffusing effect on an end surface on the divided irradiation region side and has a constant diameter throughout its length.

Still further, a display device according to a preferred embodiment of the present invention includes a display element that controls an amount of transmission light to be transmitted through pixels, thereby displaying an image in a display region, and an illumination device that irradiates each of a plurality of divided display regions obtained by dividing the display region with an amount of light controlled individually. The display device controls an amount of irradiation light from the illumination device for each of the divided display regions and transmittance of each of the pixels corresponding to the amount of irradiation light based on an input vide signal, thereby displaying an image. The illumination device includes a plurality of light sources that correspond one to one to the plurality of divided display regions and whose number is the same as that of the divided display regions, and a light transmission medium that transmits light emitted from each of the light sources to the divided display region corresponding to the light source to irradiate the same. Brightness of the plurality of light sources is controlled individually, so that the amount of irradiation light is controlled.

With this configuration, the amount of irradiation light required for displaying an image in each of the divided display regions and the transmittance of each of the pixels are obtained based on the video signal. Therefore, it is possible to obtain a display device that includes an active-backlight-type illumination device that is highly effective in achieving lower power consumption and can display a high-quality image with uniform display brightness.

In implementing the display device according to various preferred embodiments of the present invention, by adopting various preferable aspects of the above-described illumination device according to preferred embodiments of the present invention, it is possible to obtain a display device that can perform more preferable image display.

Hereinafter, preferred embodiments of an illumination device and a display device using the same according to preferred embodiments of the present invention will be described with reference to the drawings. In the following description, the display device according to various preferred embodiments of the present invention is exemplified by a liquid crystal display device for a television that includes a transmission type liquid crystal display element, and the illumination device according to preferred embodiments of the present invention is used as a backlight of the display device. However, applications of the present invention are not limited thereto. For example, a semi-transmission type liquid crystal display element can be used as a display element of the display device according to the present invention. Further, the display device according to the present invention is not limited to the liquid crystal display device for a television, but can be used as an information display monitor for use in public institutions such as a station and a museum, a computer monitor required to have a large screen, and the like.

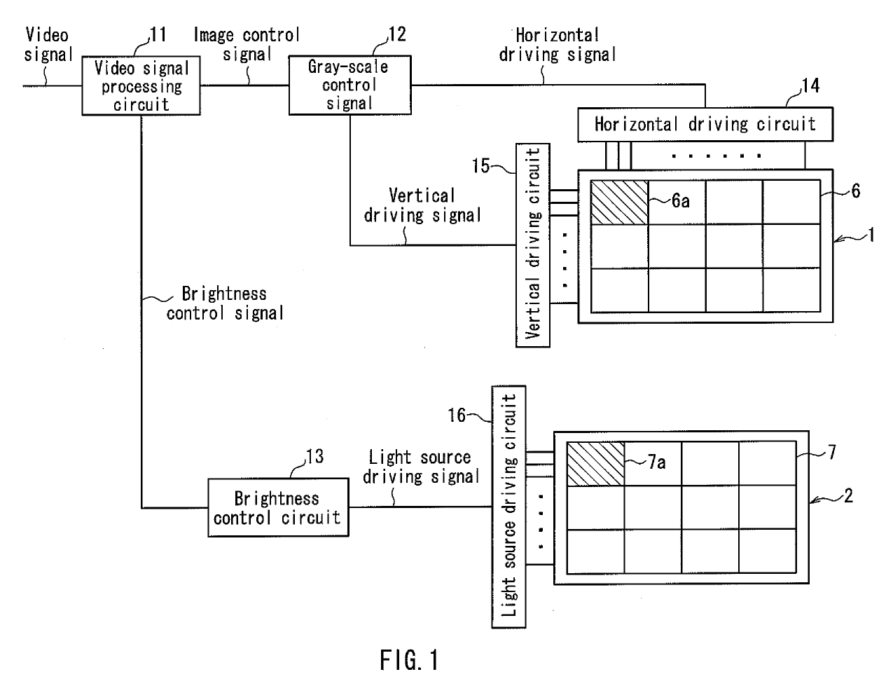

FIG. 1 is a block diagram showing a schematic configuration of a display device according to a first preferred embodiment of the present invention. As shown in FIG. 1, the display device according to the present preferred embodiment includes a liquid crystal panel 1 as a display element, a backlight unit 2 as an illumination device that irradiates transmission light required for displaying an image on the liquid crystal panel 1, as well as a video signal processing circuit 11, a gray-scale control circuit 12, a brightness control circuit 13, a horizontal driving circuit 14, a vertical driving circuit 15, and a light source driving circuit 16 for performing signal processing for displaying an image.

The liquid crystal panel 1 is a transmission type liquid crystal display element that controls an amount of transmission light to be transmitted through pixels, thereby displaying an image. The type of the liquid crystal panel 1 is not limited particularly as long as multi-gray-scale image display is possible, and may be either an active matrix type using a switching element such as a TFT or a simple matrix type. Further, the liquid crystal panel 1 may be of any of various liquid crystal display modes such as a vertically-aligned (VA) mode type, an IPS type, and an OCB type. In a central portion of the liquid crystal panel 1 other than a peripheral portion where a sealing portion, a circuit for displaying an image, a terminal portion for supplying a voltage to the liquid crystal panel 1, and the like are formed, a display region 6 in which pixels for displaying an image are formed is provided. As shown in FIG. 1, the display region 6 is divided into a plurality of regions in each of the vertical and horizontal directions of a display screen, resulting in a plurality of divided display regions 6a. Note here that each of the divided display regions 6a is a conceptual region, and thus there is no boundary or the like between the adjacent divided display regions 6a.

In the example shown in FIG. 1, the display region 6 is preferably divided into three, for example, in the vertical direction of the display screen and four, for example, in the horizontal direction, resulting in a total of twelve divided display regions 6a. However, the liquid crystal panel 1 of the display device according to the present preferred embodiment is not limited thereto. The number of the divided display regions 6a should be selected optimally as appropriate depending on the size and use of the liquid crystal panel 1, the amount of irradiation light from light sources in the backlight unit 2 to be described later, the fineness of control of a necessary amount of irradiation light from the backlight, and the like. Further, the display region 6 may not necessarily be divided in the vertical and horizontal directions of the display screen in a so-called matrix. Instead, for example, the display region 6 may be divided into a plurality of regions only in the horizontal direction, while remaining as it is in the vertical direction.

The backlight unit 2, which irradiates the display region 6 of the liquid crystal panel 1 with light from the light sources to be described later, can control an amount of irradiation light for each of the above-described divided display regions 6a of the liquid crystal panel 1. In FIG. 1, since the backlight unit 2 is taken as an illumination device with a surface light source separate from the display element, a virtual planar region formed by irradiation light from the backlight unit 2 is regarded as an irradiation region 7, which is divided into divided irradiation regions 7a. Here, the backlight unit 2 when used in the display device is combined with the liquid crystal panel 1 as a display element, so that the liquid crystal panel 1 displays an image with irradiation light from the backlight 2. Thus, the display region 6 explained in the description of the liquid crystal panel 1 corresponds to the irradiation region 7 as the backlight unit 2, and the divided display regions 6a correspond to the divided irradiation regions 7a. Eventually, it is the only difference between the display region and the irradiation region that the former is taken as a display element and the latter as an illumination device, and there is no point in differentiating between them in view of their actual application in the display device. For this reason, in the following description of the display device of preferred embodiments of the present invention, irradiation light from the backlight unit 2 as an illumination device is regarded as being irradiated onto the display region 6 and the divided display regions 6a of the liquid crystal panel 1 as a display element, which may be referred to as the “display region 6 (7)” and the “divided display regions 6a (7a)”.

Next, the following description is directed to signal processing for image display in the display device according to the present preferred embodiment. As shown in FIG. 1, the video signal processing circuit 11 generates an image control signal and a brightness control signal based on an input video signal. The brightness control signal determines the amount of irradiation light from the backlight unit 2 for each of the divided display regions 6a. For example, in the case where an image signal for a display image in one of the divided display regions 6a indicates a totally pitch black image, the amount of irradiation light for the divided display region 6a is set to 0. It should be noted that in image display on the liquid crystal panel 1, a liquid crystal layer only can block light to be transmitted therethrough, and thus cannot transmit a larger amount of light than that irradiated from the backlight unit 2. For this reason, the amount of irradiation light for each of the divided display regions 6a is controlled based on an amount of light required for a pixel that is displayed most brightly in the divided display region 6a.

Based on the amount of irradiation light to be irradiated onto each of the divided display regions 6a determined based on the above-described brightness control signal, the image control signal determines the level of gray-scale to be assigned to a pixel included in the corresponding divided display region 6a. Namely, the image control signal controls transmittance in each pixel. As described above, in the display device according to the present preferred embodiment, the amount of irradiation light to be irradiated from the backlight unit 2 onto each of the divided display regions 6a always varies. Thus, unless each pixel is assigned with transmittance corresponding to the amount of irradiation light, the amount of transmission light in the pixel cannot be controlled accurately. For this reason, even if the amount of transmission light in each pixel as one luminescent spot for image display is the same, the gray-scale signal for determining transmittance in the pixel is different when the amount of light irradiated from the backlight unit 2 varies.

The image control signal is input to the gray-scale control circuit 12 as an image signal with gray-scale information that accommodates active backlight display of a preferred embodiment of the present invention, and is divided into a horizontal driving signal and a vertical driving signal, so that one image can be displayed by scanning in the vertical and horizontal directions. The horizontal driving signal and the vertical driving signal drive the horizontal driving circuit 14 and the vertical driving circuit 15, respectively. The vertical and horizontal scanning for image display is performed in the same manner as that for driving a liquid crystal panel using a usual backlight that always irradiates light having uniform brightness unlike the active backlight type. The liquid crystal panel according to the present preferred embodiment is driven in a manner different from that of the conventional liquid crystal panel only in that the gray-scale signal assigned as described above corresponds to the amount of light from the backlight.

The brightness control signal is input to the brightness control circuit 13, and in order to obtain the amount of irradiation light to be irradiated onto each of the plurality of divided display regions 6a, the brightness control circuit 13 generates a light source driving signal for adjusting the brightness of the light source corresponding to each of the divided display regions 6a to irradiate light thereon. The light source driving signal is input to the light source driving circuit 16, and the light source driving circuit 16 controls a voltage or current to be applied to each of the light sources in the backlight unit 2 individually, so that the light source emits light having desired brightness at a desired timing to irradiate a necessary amount of light.

In this manner, the active backlight type according to the present preferred embodiment makes it possible to reduce the amount of irradiation light from the backlight in a portion that does not contribute to image display, thereby achieving lower power consumption of the backlight unit. Further, in the case of the active backlight type, it is highly likely that the amount of irradiation light from the backlight unit 2 can be suppressed in the divided display region 6a that is required to display a black image. Thus, a phenomenon so-called a “backlight bleeding”, which is caused due to an inevitable leakage of light in each pixel of the liquid crystal panel 1, can be minimized and prevented. Therefore, by using the active backlight type, it is possible to achieve high gray-scale image display on the liquid crystal panel, as well as to reduce power consumption for lighting the backlight.

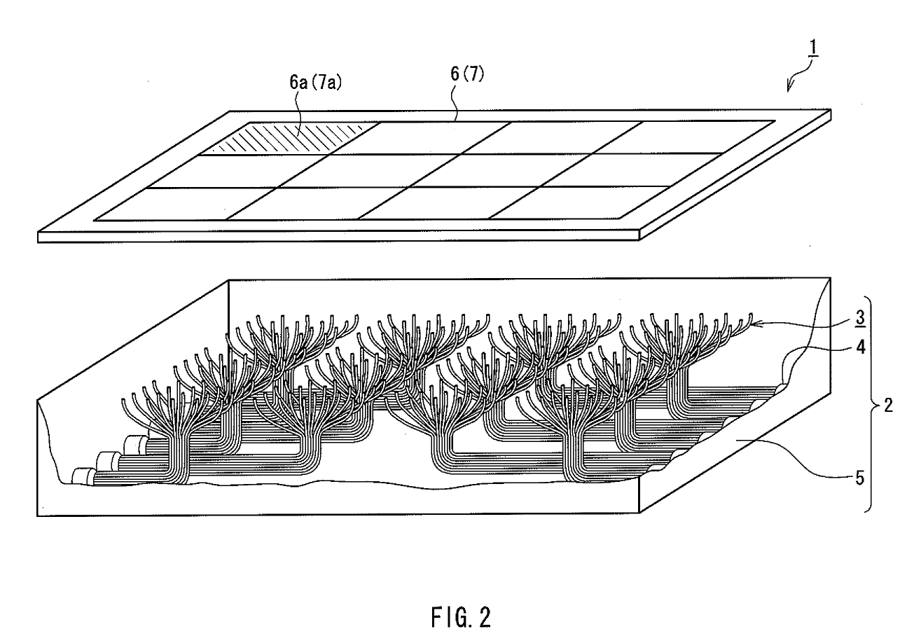

Next, the configuration of the backlight unit 2 in the display device according to a preferred embodiment of the present invention will be described with reference to FIG. 2. FIG. 2 is an exploded perspective view of the display device according to a preferred embodiment of the present invention. The various signal processing circuits and driving circuits for processing the image signal as shown in FIG. 1 are not shown in FIG. 2.

Although not shown in the figure, the liquid crystal panel 1, which preferably is a transmission type active matrix liquid crystal element, includes a liquid crystal layer sandwiched between two glass substrates sealed together. In the central portion of the liquid crystal panel 1, the display region 6 in which a number of pixels for displaying an image are arranged in a matrix is formed. As shown also in FIG. 1, the display region 6 is preferably divided into three, for example, in the vertical direction of the display screen and four, for example, in the horizontal direction, resulting in a total of twelve divided display regions 6a, for example. Although not shown in FIG. 2, in order to allow the liquid crystal layer to control the amount of transmission light in each pixel, polarizing plates are provided respectively on the front and back surfaces of the liquid crystal panel 1 so as to polarize light in different directions.

The backlight unit 2 includes a bottomed frame 5, white light-emitting diodes 4 as light sources fixed to short-side side walls of the frame 5, and optical fibers 3 as a light transmission medium that transmit light emitted from each of the white light-emitting diodes 4 to irradiate the corresponding divided display region 6a therewith. Since the white light-emitting diodes 4 as light sources correspond one to one to the divided display regions 6a, the number of the white light-emitting diodes 4 in the display device of the present preferred embodiment is the same as that of the divided display regions 6a, i.e., twelve.

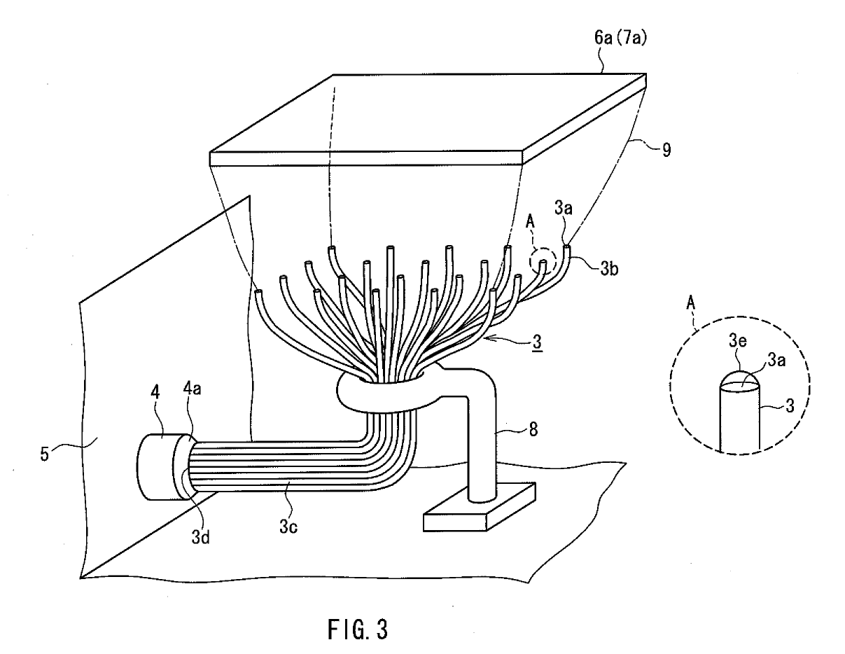

Next, the white light-emitting diodes 4 as light sources and the optical fibers 3 as a light transmission means will be described in more detail with reference to FIG. 3. FIG. 3 is an enlarged perspective view of a main portion of the backlight unit 2 according to the present preferred embodiment, showing the white light-emitting diode 4 that irradiates light onto the corresponding one of the divided display regions 6a, and the optical fibers.

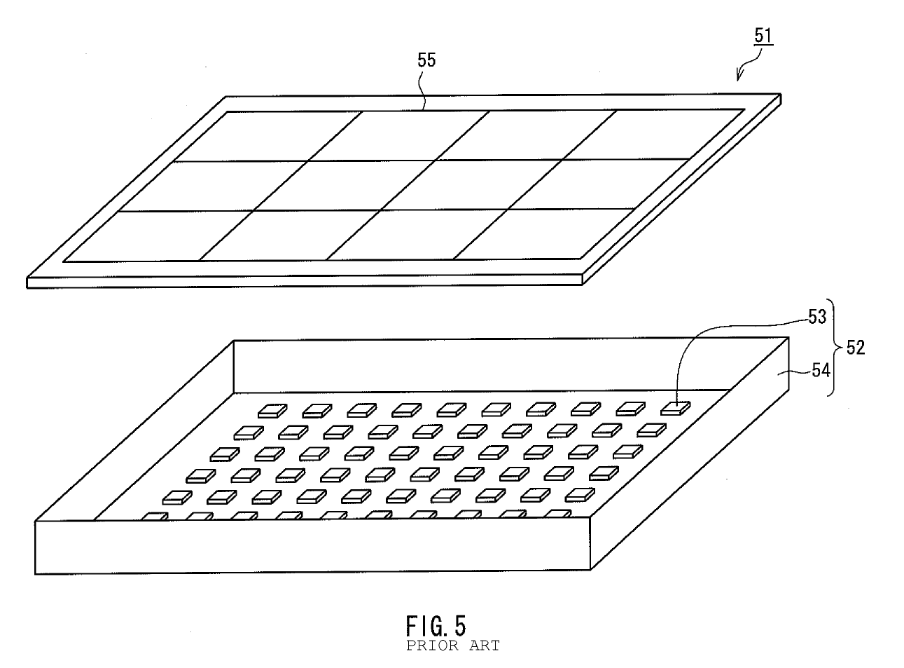

As shown in FIG. 3, the white light-emitting diode 4 is fixed to the side wall of the frame 5 of the backlight unit 2. The light-emitting diode in use preferably is a round type light-emitting diode including a cylindrical base having a diameter of about 5 mm to about 10 mm and a substantially dome-shaped projection formed at the end of the base. The round type light-emitting diode has a rated current of about 100 mA to about 150 mA, allowing a large current to flow therethrough, and emits a larger amount of irradiation light than a chip-mounted light-emitting diode used in the conventional active-backlight-type backlight as shown in FIG. 5.

One end portion 3d of the optical fibers 3 is arranged so as to be opposed to a light-emitting surface 4a of the white light-emitting diode 4. Each of the optical fibers 3 according to the present preferred embodiment is a so-called power transmission fiber that transmits at least light in a visible light region and uses quartz glass as a core material, and has a diameter of about 1 mm in cross section. From the one end portion 3d of the optical fibers 3 opposed to the light-emitting surface 4a of the white light-emitting diode 4 to an intermediate portion 3c, the plurality of optical fibers 3 are held in a bundle. However, at the other end portion of the optical fibers 3, i.e., an end portion 3b on a side of the divided display region 6a to be irradiated with light, the optical fibers 3 extend radially as shown in FIG. 3. This is because it is necessary to irradiate irradiation light 9 onto the whole divided display region 6a that has a larger area than the light-emitting surface 4a of the white light-emitting diode 4 as a light source.

Further, as shown in an enlarged view in FIG. 3, a fine convex lens shape 3e may be formed on an end surface 3a of each of the optical fibers 3 on the divided display region 6a side, so that the irradiation light 9 emitted from the optical fiber 3 can spread out easily. Consequently, a distance between the end surface 3a of the optical fiber 3 and the divided display region 6a can be reduced, which allows the backlight unit 2 to be thinner.

It is preferable that the optical fibers 3 extend radially at the end portions 3b on the divided display region 6a side such that vicinities of the end surfaces 3a of the optical fibers 3 on the divided display region 6a side are perpendicular or substantially perpendicular to the divided display region 6a as shown in FIG. 3. Consequently, the irradiation light 9 emitted from the optical fibers 3 is incident on the divided display region 6a perpendicularly or substantially perpendicularly, so that the brightness of the irradiation light 9 in the divided display region 6a can be made uniform more easily.

As described above, the white light-emitting diodes 4 capable of controlling brightness on its own are used in the active-backlight-type backlight unit, and light irradiated from each of the white light-emitting diodes 4 is transmitted through the optical fibers 3 as a light transmission medium so as to be irradiated onto the corresponding divided display region 6a. Thus, the light sources, which conventionally have been required to be arranged directly behind the back surface of the divided display regions 6a, can be disposed as appropriate in any portion other than directly behind the back surface of the divided display regions 6a. Consequently, it is possible to realize an active-backlight-type backlight unit that can irradiate each of the divided display regions 6a with light having predetermined brightness by solving the problem of the conventional backlight unit 2 that the light-emitting diode as a light source varies in temperature characteristics under the influence of heat radiated from other surrounding light-emitting diodes, so that brightness cannot be controlled at a predetermined value.

In FIGS. 1 and 2 illustrating the above-described preferred embodiment, the image display region of the liquid crystal panel is preferably divided into three vertically and four horizontally, for example, resulting in a total of twelve divided display regions, for example. However, the display device of the present invention is not limited thereto. In particular, the effect of reducing power consumption and performing high gray-scale display due to the active backlight type is achieved more remarkably when the distribution of brightness for image display is more uniform in each of the divided display regions. This is because, even if one of the divided display regions includes a pixel for displaying a black image, irradiation brightness in the divided display region cannot be reduced when a pixel for displaying a white peak is included in the divided display region. Thus, in view of the size of the inside of a light source box of the backlight unit and cost, it is preferable to provide as many divided display regions as possible, as long as a problem of how many pairs of the light sources and the light transmission media can be disposed is eliminated.

In the present preferred embodiment, the white light-emitting diodes as light sources are preferably provided on the short-side side walls of the backlight unit. However, the display device and the illumination device for use in the display device according to the present invention are not limited thereto. They may be provided not only on the short-side side walls but also on long-side side walls, or may be provided on the bottom of the light source box, i.e., on a surface on the back surface side of the liquid crystal panel. In any case, since the backlight unit of various preferred embodiments of the present invention includes the light transmission medium for directing light from the light sources to the divided display regions, there is no such limitation that the light sources should be disposed directly behind the back surface of the divided display regions. Thus, it is possible, for example, to locate the light sources so that heat therefrom does not remain in view of the structure of the backlight, to adjust the space between the light sources so as to prevent each of the light sources from being influenced by heat generated from the adjacent light sources, and to provide a mechanism for dissipating heat to the outside such as a cooling fin and a heat dissipating fan, so as to concentrate the light sources in the vicinity thereof.

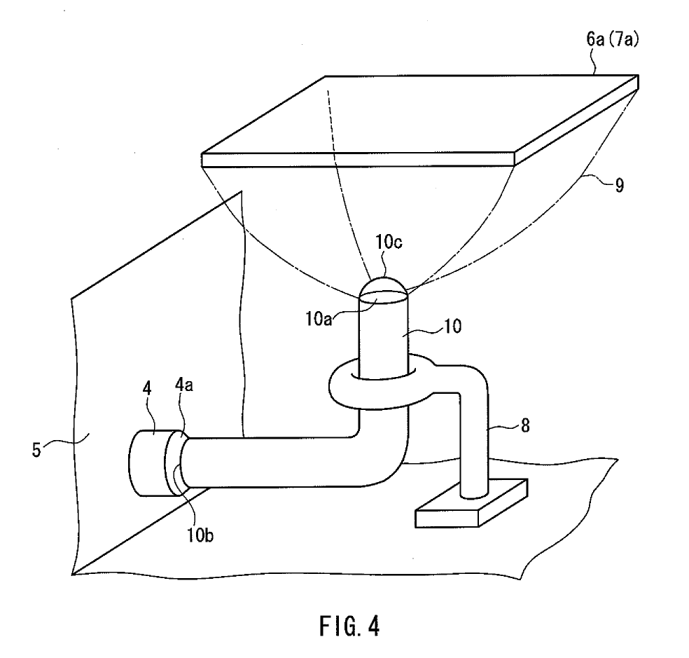

Next, a second preferred embodiment of the display device according to the present invention will be described with reference to FIG. 4. FIG. 4 is an enlarged perspective view of a main portion showing the relationship among a light source, a light transmission medium, and a divided display region irradiated with light from the light source in the display device of the second preferred embodiment. FIG. 4 corresponds to FIG. 3 referred to in the above-described first preferred embodiment of the display device of the present invention.

As shown in FIG. 4, a backlight unit 2 according to the present preferred embodiment is different from that in the first preferred embodiment described above with reference to FIG. 3 in that a light transmission medium for directing light irradiated from a white light-emitting diode 4 as a light source to a divided irradiation region 6a corresponding to the white light-emitting diode 4 is a light guide 10 having a constant diameter throughout its length. The basic components other than the light guide 10 as a light transmission medium are preferably the same as those in FIG. 3, and thus the description thereof will not be repeated.

As shown in FIG. 4, the light transmission medium used in the backlight unit according to the second preferred embodiment is the light guide 10 having a predetermined diameter. As its name implies, the light guide 10 transmits light incident on one end to the other end to emit the same, and examples thereof include a collection of a number of optical fibers, a structure formed in a predetermined shape from highly transparent acrylic resin or quartz glass as used in an optical fiber, and a hollow cylindrical structure containing an optical lens therein. It should be noted that the light guide 10 in the display device according to the present preferred embodiment is assumed to have substantially the same diameter as that of a light-emitting surface 4a of the light-emitting diode 4 as a light source, and does not include usual optical fibers as described in the first preferred embodiment, each having a significantly smaller cross-sectional area than the light-emitting surface 4a of the white light-emitting diode 4.

As shown in FIG. 4, the light guide 10 is supported and fixed by a supporting member 8 such that one end 10b thereof is disposed so as to be opposed to the light-emitting surface 4a of the white light-emitting diode 4 as a light source and the other end 10a is disposed so as to be opposed to the divided display region 6a. Unlike the plurality of optical fibers 3 used as a light transmission medium in the display device according to the preferred embodiment of the present invention shown in FIG. 3, the light guide 10 is one optical member that has substantially the same diameter throughout its length, and thus cannot extend radially at an end portion on the divided display region 6a side. Therefore, in order to eliminate a difference in area between the white light-emitting diode 4 and the divided display region 6a, it is necessary to form on the end surface 10a of the light guide 10 on the divided display region 6a side an optical member such as a convex lens 10c that has a light diffusing effect of widening a light path for irradiation light 9.

Further, on the end surface 10b of the light guide 10 on the white light-emitting diode 4 side, a member having a so-called optical coupling effect may be applied by, for example, covering a gap between the light-emitting surface 4a of the white light-emitting diode 4 and the end surface 10b of the light guide 10 with transparent resin, thereby allowing light emitted from the white light-emitting diode 4 to be incident on the light guide 10 more efficiently.

The description has been given of the preferred embodiments of the display device according to the present invention particularly with respect to the configuration of the backlight unit. However, the present invention is not limited to these specific examples. For example, the white light-emitting diode is used as a light source in the above-described preferred embodiments because the light-emitting diode is appropriate in terms of responsiveness to the brightness control signal and the amount of irradiation light. Accordingly, another light source such as an EL element, a discharge element, and a fluorescent tube is also available, as long as it can respond to the brightness control signal sufficiently and produce a sufficient amount of irradiation light. Further, the white light-emitting diode is used because color display on the liquid crystal panel usually requires a white light source and color filters of three colors of RGB formed in the liquid crystal panel. Accordingly, the light source is not necessarily limited to the white light source when used in a display device that does not perform color display, or depending on the combination with colors of the color filters formed in the liquid crystal panel even when used in a display device that performs color display. Needless to say, light of a necessary color may be irradiated as appropriate.

Further, in order to ensure and improve the uniformity of the amount of irradiation light in the divided display region, an optical diffuser having a function of scattering irradiation light or the like may be provided between the end portion of the light transmission medium on the light emission side and the divided display region. The light diffuser in this case can be a diffuser to be provided between a usual direct-type backlight light source and a liquid crystal panel in a liquid crystal display device.

The present invention is industrially applicable as an illumination device usable as an active-backlight-type backlight that is suitable for achieving lower power consumption of a display device and higher gray-scale image display, and a display device using the illumination device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13. An illumination device capable of irradiating each of a plurality of divided irradiation regions with an amount of light controlled individually, the illumination device comprising:
a plurality of light sources that correspond one to one to the plurality of divided irradiation regions and whose number is the same as that of the divided irradiation regions; and
a light transmission medium arranged to transmit light emitted from each of the light sources to the divided irradiation region corresponding to the light source to irradiate light onto the respective divided irradiation region; wherein
brightness of the plurality of light sources is controlled individually such that an amount of light irradiated onto each of the plurality of divided irradiation regions is controlled.

14. The illumination device according to claim 13, wherein each of the light sources is provided on a side wall of a light source box containing the light sources and the light transmission medium therein.

15. The illumination device according to claim 13, wherein the light sources are white light-emitting diodes.

16. The illumination device according to claim 13, wherein the light transmission medium is an optical fiber.

17. The illumination device according to claim 16, wherein the light transmission medium is a collection of a plurality of the optical fibers, which extend radially at an end portion on the divided irradiation region side.

18. The illumination device according to claim 13, wherein the light transmission medium is a light guide that includes an optical member having a light diffusing effect on an end surface on the divided irradiation region side and has a constant diameter throughout its length.

19. A display device comprising:
a display element arranged to control an amount of transmission light to be transmitted through pixels so as to display an image in a display region; and
an illumination device arranged to irradiate each of a plurality of divided display regions obtained by dividing the display region with an amount of light controlled individually; wherein
the display device is arranged to control an amount of irradiation light from the illumination device for each of the divided display regions and transmittance of each of the pixels corresponding to the amount of irradiation light based on an input vide signal, thereby displaying an image;
the illumination device includes:
a plurality of light sources that correspond one to one to the plurality of divided irradiation regions and whose number is the same as that of the divided irradiation regions; and
a light transmission medium arranged to transmit light emitted from each of the light sources to the divided irradiation region corresponding to the light source to irradiate light onto the respective divided irradiation region; wherein
brightness of the plurality of light sources is controlled individually such that an amount of light irradiated onto each of the plurality of divided irradiation regions is controlled.

20. The display device according to claim 19, wherein each of the light sources is provided on a side wall of a light source box containing the light sources and the light transmission medium therein.

21. The display device according to claim 19, wherein the light sources are white light-emitting diodes.

22. The display device according to claim 19, wherein the light transmission medium is an optical fiber.

23. The display device according to claim 22, wherein the light transmission medium is a collection of a plurality of the optical fibers, which extend radially at an end portion of the collection of the optical fibers on the divided display region side.

24. The display device according to claim 19, wherein the light transmission medium is a light guide that includes an optical member having a light diffusing effect on an end surface on the divided display region side and has a constant diameter throughout its length.
